(19) United States
(12) Patent Application Publication
(10) Pub. No.: US 2009/0044730 A1
(43) Pub. Date: Feb. 19, 2009

(54) COIN SORTER

(76) Inventor: Lamont Boegli, Port Richey, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/945,419

(22) Filed: Nov. 27, 2007

Related U.S. Application Data
(60) Provisional application No. 60/956,400, filed on Aug. 17, 2007.

(51) Int. Cl. A47B 37/00; G07D 9/06

(52) U.S. Cl. 108/50.11; 453/62

(57) ABSTRACT

A sorter device for sorting state quarters by State, year and mint location for each State quarter or for generally sorting pennies, nickels, dimes and quarters. It is in the form of a table with spaced-apart holes having depending funnel cones in which a coin wrapper is inserted. Identifying indicia that identifies desired information related to the coins to be sorted such as State, year, mint location, coin value or graphical images of the coins to be sorted is also included.

### RELATED APPLICATION

This application claims the benefit of U.S. provisional patent application Ser. No. 60/956,400 filed Aug. 17, 2007

### FIELD OF THE INVENTION

The invention relates to a sorter device for sorting state quarters by State, year and mint location for each State quarter and for sorting pennies, nickels, dimes and quarters, into a designated coin wrapper.

### BACKGROUND OF THE INVENTION

For individuals who collect State quarters, it can be relatively cumbersome to sort out the minted state quarters. Quarters literally have to be spread out across the table and/or floor and it is very time consuming. It requires a lot of patience. What is needed is a systematic system that provides for an orderly sorting of the quarters and makes the sorting effort fun.

Similarly for individuals who save coins and throw them into a container for sorting them later, what is needed is a systematic system that provides for an orderly sorting of coins that makes saving and the sorting effort fun.

### SUMMARY OF THE INVENTION

The invention is a sorting device in the form of a table. It can be about 10 1/2 inches long, about 7¾ inches wide and about 4½ inches high for a state quarter sorter and about 8½ inches long, about 6½ inches wide and about 4½ inches high. The table would have a plurality of funnel like spaced-apart holes on the top surface member of the table with funnel like appendages depending from each hole, which serve as means for attaching a corresponding coin wrapper to each depending funnel portion. Typically, the coin wrapper could be dropped into the funnel portion so that the coin wrapper drops to nearly approximate the table leg height or juxtaposed the surface on which the table legs rest. The lower end of the funnel portion is diametrically sized to that the wrapper upper end snuggly fits or touches against a perimeter of the lower end inside cone surface of the funnel portion.

In the preferred embodiment for the state quarter sorter, the table would have an array of five funnel like holes on one side of the table top and an opposite array of five funnel like holes on the other side of the table top. For the general coin sorter, the table would have two parallel rows of four spaced-apart funnel like holes for designated coins reflective of each of the coins to be sorted and wrapped, that is, pennies, nickels, dimes and quarters.

A designated indicia area between the arrays of the funnel like holes may optionally be included, in which a label or card having identifying indicia can be located permanently or be removably attached resting on the area. Of course, the identifying indicia label/card may also be located between the opposite arrays of holes, within an indented designated area.

For the state quarter sorter embodiment, the indicia can include information related to the coins being sorted, such as the year, State, Mint location (“D” for Denver and “P” for Philadelphia), or even the picture of the state coin to be sorted. Any combination of the above indicia may be presented on the label/card or information data sheet. For the general coin sorter, the indicia can include text identifying the coin, a picture of the coin, or any combination of these.

The complete sorting apparatus may be made from almost any desired materials, although the most common is expected to be plastic base or polymeric base composite materials.

It is preferred that the table legs be removable for better break down and storage of the coin sorter table when not in use.

Although one objective of the invention is to provide a sorter for State quarters, another is to provide a device to sort common coins such as pennies, nickels, dimes and quarters from each other.

### BRIEF DESCRIPTION OF THE DRAWINGS

In the accompanying drawings:

FIG. 1 is a conceptual representational depiction of the assembled invention representative of the state quarter sorter without the coin wrappers attached to the funnel portion;

FIG. 2 is a representation of example of data/indicia sheets that can be used with the state quarter sorter invention with typical kinds of specific information that can be shown for a related State coin to be sorted;

FIG. 3 is a conceptual representational depiction of the assembled invention representative of the general coin sorter with two visible ends of coin wrappers attached to respective funnel portions; and

FIG. 4 is a conceptual representational depiction of the invention of depicted in FIG. 3 viewed perspectively from the underside of the invention with four coin wrapper depending from respective funnel portions.

### DETAILED DESCRIPTION OF THE INVENTION

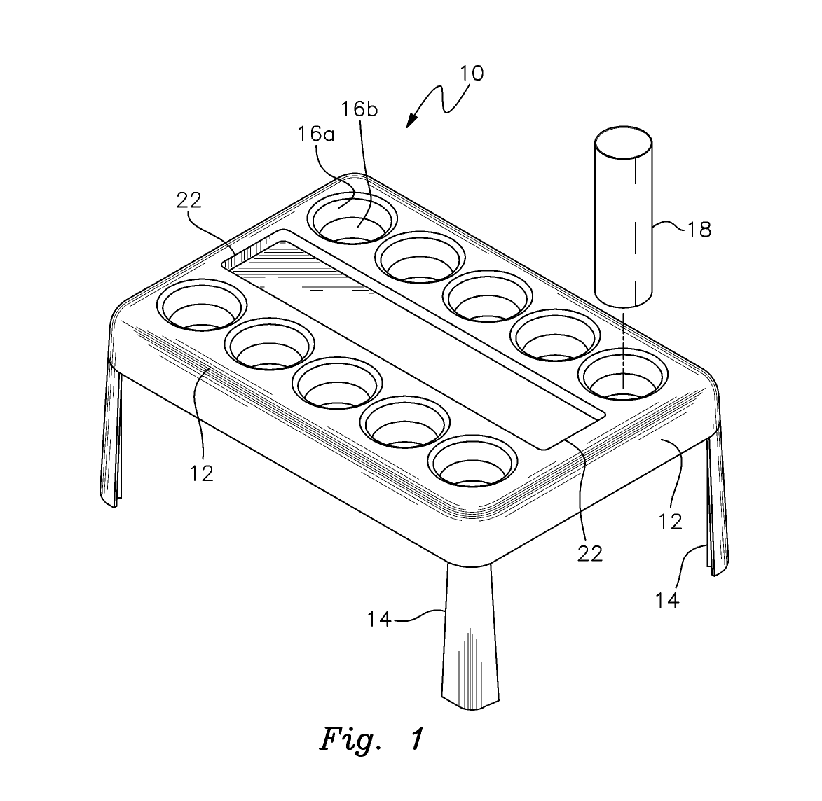

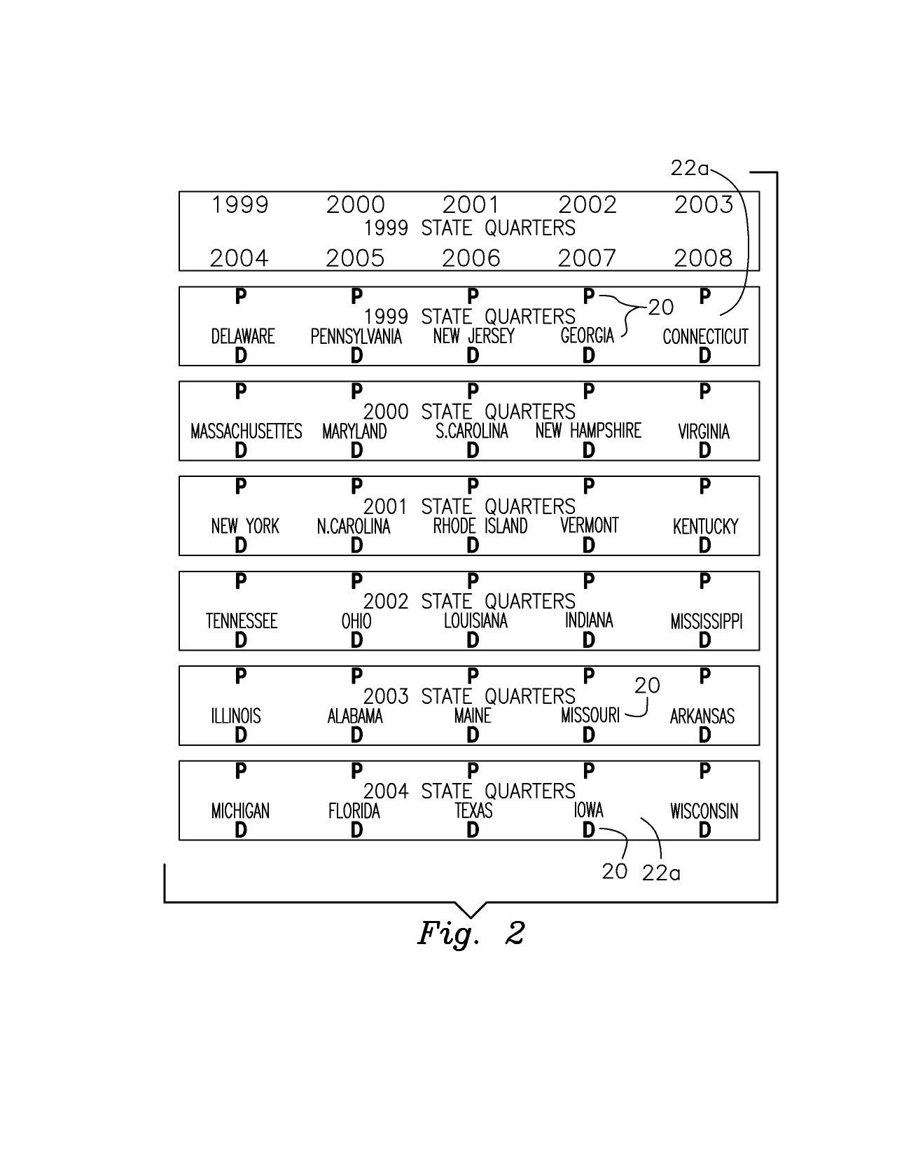

Referring to the drawings, one embodiment of the invention as depicted in FIGS. 1 and 2, is a sorting device 10 in the form of a table 12 with preferably removable legs 14, as opposed to fixed legs. For the embodiment to sort state quarters, it device 10 can be about 10½ inches long, about 7¾ inches wide and about 4½ inches high for a state quarter sorter and about 8½ inches long, about 6½ inches wide and about 4½ inches high. The table 12 would have a plurality of funnel like spaced-apart holes 16b on the top surface member of the table 12 with funnel like appendages 16a depending from each hole 16b, which serve as means for attaching a corresponding coin wrapper 18 to each depending funnel portion 16a. Typically, the coin wrapper 18 could be dropped into the funnel portion 16a so that the coin wrapper 18 drops to nearly approximate the table leg height or juxtaposed the surface on which the table legs 14 rest. The lower end of the funnel portion 16a is diametrically sized to that the wrapper 18 upper end snuggly fits or touches against a perimeter of the lower end inside cone surface of the funnel portion 16a.

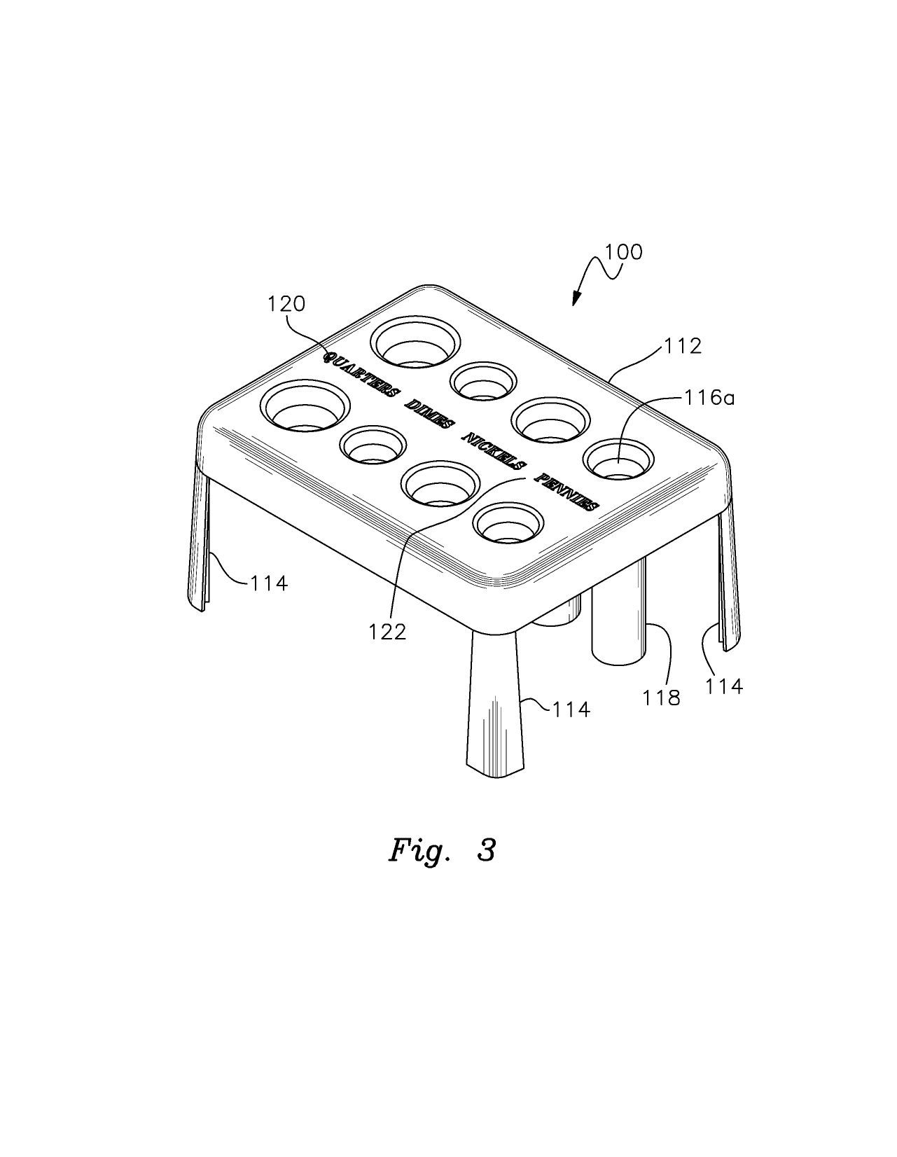

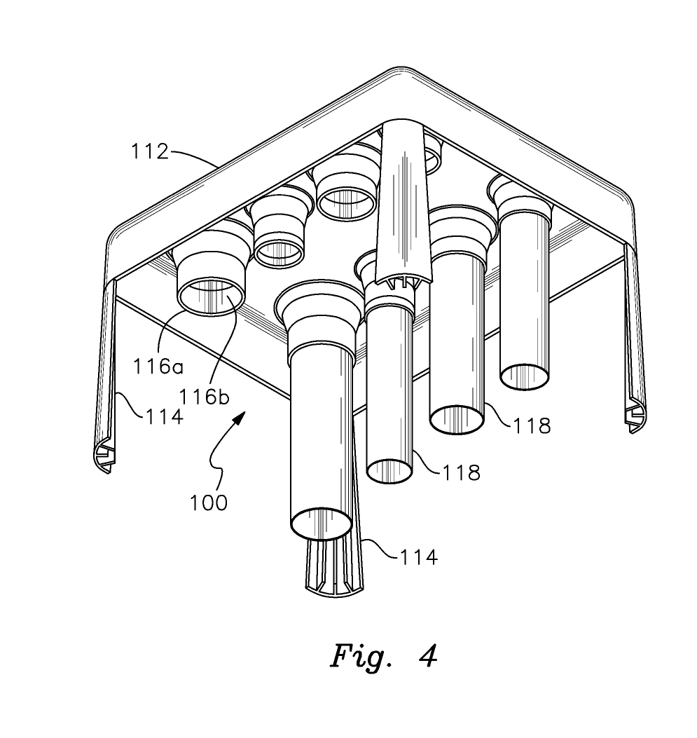

In the preferred embodiment for the state quarter sorter 10, the table 12 would have an array of five funnel like holes 16b on one side of the table 12 top and an opposite array of five funnel like holes 16b on the other side of the table 12 top. For the general coin sorter 100 described below and depicted conceptually in FIGS. 3 and 4, the table 112 would have two parallel rows of four spaced-apart funnels 116a and funnel holes 116b for designated coins reflective of each of the coins to be sorted and wrapped, that is, pennies, nickels, dimes and quarters.

A designated indicia area 22,122 between the arrays of the funnel like holes 16b,116b may optionally be included, in which a label or card 22a (usable in both embodiments but conceptually shown for both embodiments in FIGS. 1 and 2) having identifying indicia 20,120 can be located permanently or be removably attached resting on the area 22,122. Of course, indicia 20,120 may be printed, imbedded in the material, or on labels. If a label 22a is used, the identifying indicia label/card 22a may also be located between the opposite arrays of holes 16b,116b, within an indented designated portion of the indicia area 22 as shown conceptually in FIG. 1. Again, an indented area could be incorporated in the FIG. 3 embodiment.

For the state quarter sorter embodiment 10, the indicia 20 can include information related to the coins being sorted, such as the year, State, Coin Mint location (“D” for Denver and “P” for Philadelphia), or even the picture or graphical pictorial image of the state coin to be sorted. Any combination of the above indicia may be presented on the label/card or information data sheet 22a. For the general coin sorter, the indicia 120 can include text identifying the coin, a picture or graphical pictorial image of the coin, or any combination of these. FIG. 2 depicts examples of identifying indicia 20,120 on labels 22a that may be placed on the table 12,112 or located within the indicia area 22 of the table 12,112. The indicia area 22 may be indented as shown in FIG. 1. The indented indicia area 22 is not shown in FIG. 3 but it is understood that its depiction in FIG. 1 is representative of its incorporation in FIG. 3.

The complete sorting apparatus may be made from almost any desired materials, although the most common is expected to be plastic base or polymeric base composite materials.

It is preferred that the table legs 14,114 be removable for better break down and storage of the coin sorter table 12,112 when not in use.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by their equivalents.

1. A coin sorting device comprising:
a table having legs to support said table on a working surface;
said table having a plurality of spaced-apart holes on a top surface of the table with funnel-shaped portions depending from each hole, said appendages serving as means for attaching a corresponding coin wrapper to each of said depending funnel portions,
wherein coin wrapper is dropped into said funnel portion, the table height being sufficient such that said coin wrapper drops to approximate said table leg height, juxtaposed said working surface on which said table legs rest.

2. The device according to claim 1, wherein said legs are removable for ease of storing said device.

3. The device according to claim 1, wherein a lower end of the funnel-shaped portion is diametrically sized to that an upper end of said coin wrapper snuggly fits or touches against a perimeter of a lower end inside cone surface of the funnel-shaped portion.

4. The device according to claim 1, wherein said table further comprises two parallel rows of five spaced-apart holes, said holes and depending funnel-shaped portions being sized for sorting quarters to be wrapped.

5. The device according to claim 1, wherein said table further comprises two parallel rows of four spaced-apart holes, said holes and depending funnel-shaped portions being sized for sorting designated coins to be wrapped, said coins being pennies, nickels, dimes and quarters.

6. The device according to claim 1, further comprising a designated indicia area for indicating coin identifying indicia.

7. The device according to claim 6, wherein said designated indicia area is an indented portion on the surface of the table in which an indicia label sheet is located.

8. The device according to claim 6, wherein said coin identifying indicia includes, indicia one or more of: State, Coin Mint Location, graphical pictorial image of coin, and coin related text.
